(19) United States
(12) Patent Application Publication
(10) Pub. No.: US 2021/0361046 A1
(43) Pub. Date: Nov. 25, 2021

(54) PORTABLE KIT FOR STORING PEN

(71) Applicant: Won JEON, Gwangju-si (KR)

(72) Inventor: Won JEON, Gwangju-si (KR)

(21) Appl. No.: 16/342,242

(22) PCT Filed: Jan. 18, 2019
(86) PCT No.: PCT/KR2019/000747

§ 371 Date: Apr. 16, 2019

(30) Foreign Application Priority Data
Jul. 17, 2018 (KR) 20-2018-0003267

(51) Int. Cl. A45C 11/34; A45C 13/02; B43K 31/00; B43K 23/008; B43K 23/12; B43K 24/00; B43K 8/00; G06F 3/038; G06F 3/0354

(52) U.S. Cl. CPC A45C 11/34; A45C 13/02; B43K 31/00; B43K 23/008; G06F 3/03545; B43K 24/00; B43K 8/003; G06F 3/038; B43K 23/12

(57) ABSTRACT

A portable kit for storing a pen according to the present invention includes a base in which an accommodation portion is famed. The pen is fastened to the accommodation portion, and is coupled to a coupling kit having a shape corresponding to that of the accommodation portion and accommodated in the accommodation portion. A grip portion is formed on the coupling kit, and allows the pen to be withdrawn from or retracted into the base in such a manner that the grip portion is pushed with a finger.

### TECHNICAL FIELD

The present invention relates generally to a portable kit for storing a writing tool such as a pen, and more specifically to a portable kit that can accommodate and carry a pen without concern about loss and damage, has an excellent appearance, and is robust and compact.

### BACKGROUND ART

With the recent diversification and development of electronic devices, many electronic parts attachable to and detachable from electronic devices, such as chips, USIMs, or memory used for electronic devices, electronic pens intended to operate electronic devices, or the like, have appeared. Meanwhile, since these electronic parts are compact and small, disadvantages arise in that they are likely to be lost, they are not easy to find when they are lost, and it is difficult to easily find where they are placed when necessary. In particular, when a user goes out for a long time for a tour or business trip, it is troublesome to possess and carry electronic parts to be replaced or added, and care should be taken not to be lost or damaged.

A tool frequently required during a tour or business trip is a writing pen or electronic pen. The pen is easy to lose because it is small in size, it is difficult to carry the pen in clothes because it has a long length and a sharp tip, and the pen occupies a considerable volume even when it is stored in a bag or case. In order to mitigate these disadvantages, it may be possible to consider downsizing it by reducing the size of the pen itself and providing a case or kit suitable for the pen.

Meanwhile, as an example of technology proposed for the purpose of arranging and accommodating parts, Korean Utility Model Registration No. 20-446324 discloses a part storage container including: a case configured to have an open front, shelves configured to partition the internal space of the case, vertical panels configured to be withdrawn through the open front of the case, and boxes configured to be attached to and detached from the left and rights of the vertical panels and to store parts therein, wherein the vertical panels and the boxes are installed inside the internal space partitioned by the shelves. Korean Patent No. 10-0592703 discloses a multi-panel type case for storing LCD parts, wherein rectangular or square spaces are formed according to variously sized holes suitable for parts or commercial LCD display panels, segmental panels are designed/fabricated by division into various sizes according to the sizes of parts and the shapes of the front and back sides of the case, and an electronic circuit designer or consumers are allowed to select desired segmental panels according to the types of parts to be placed on the front and back sides of the case from among the fabricated panels for fastening parts. However, since these conventional technologies are basically configured such that a user arranges relatively bulky members or parts in selected spaces, they are disadvantageous in terms of the compactness of a case and are poor in merchantability. Therefore, they are not suitable for use as a compact case for storing electronic parts.

### DISCLOSURE

### Technical Problem

Therefore, it is an object of the present invention to provide a compact and light portable kit which can accommodate a pen.

It is another object of the present invention to provide a portable kit which allows whether or not a pen is accommodated to be easily checked and also allows a pen to be conveniently withdrawn and retracted.

### Technical Solution

In order to accomplish the above objects, the present invention provides a portable kit for storing a pen, the portable kit including a base in which an accommodation portion is formed, wherein the pen is fastened to the accommodation portion and is coupled to a coupling kit having a shape corresponding to that of the accommodation portion and accommodated in the accommodation portion, and a grip portion is famed on the coupling kit and allows the pen to be withdrawn from or retracted into the base in such a manner that the grip portion is pushed with a finger.

The accommodation portion may include a long rectangular main accommodation portion and a small, long rectangular auxiliary accommodation portion protruding from one side of the main accommodation portion, a stop portion may be formed to protrude from one side of the auxiliary accommodation portion, and a fastening portion may be formed to protrude from one end of the auxiliary accommodation portion.

The coupling kit may include a body and a grip portion protruding upward from a top surface of one side of the body, a guide configured to accommodate the pen may be formed at the center of the body, a hook may be formed from one side of the body in an integrated manner, and a catch protrusion having the same shape as the stop portion may be formed on a side surface of the hook, so that the coupling kit is slidable between a retracted position in which the catch protrusion engages with the stop portion of the accommodation portion and an advanced position in which the catch protrusion engages with the fastening portion of the accommodation portion.

A push portion may be vertically formed on the top surface of one end of the hook.

The pen may be a writing tool having a long steel core shape in which an ink source is contained.

The pen may be an electronic pen having a chip including a controller and a tip for pressing a screen.

The portable kit may further include a cover which selectively opens and closes the base, and a window through which the grip portion is exposed and along which the grip portion is movable may be opened and formed in the cover.

### Advantageous Effects

The present invention provides an effect of providing the robust and compact portable kit which allows a pen to be conveniently accommodated and withdrawn.

The present invention provides an effect of providing the portable kit which eliminates the risk of loss of a pen required during a tour or business trip, is convenient, and has excellent merchantability.

### DESCRIPTION OF DRAWINGS

FIG. 1 is a perspective view of the base of a portable kit according to the present invention;

FIG. 2 is a perspective view showing operations of advancing and retracting the coupling kit shown in FIG. 1;

FIG. 3 is a perspective view of a base according to another embodiment of the present invention;

FIG. 4 is a perspective view showing a state in which the cover of the portable kit for storing a pen according to the present invention has been closed;

FIG. 5a is a perspective view of a portable kit according to another embodiment of the present invention; and

FIG. 5b is a perspective view of a state in which the cover of the portable kit shown in FIG. 5a has been closed.

### MODE FOR INVENTION

The structure of a portable kit 1 for storing a pen according to the present invention will be described in detail below with reference to the accompanying drawings.

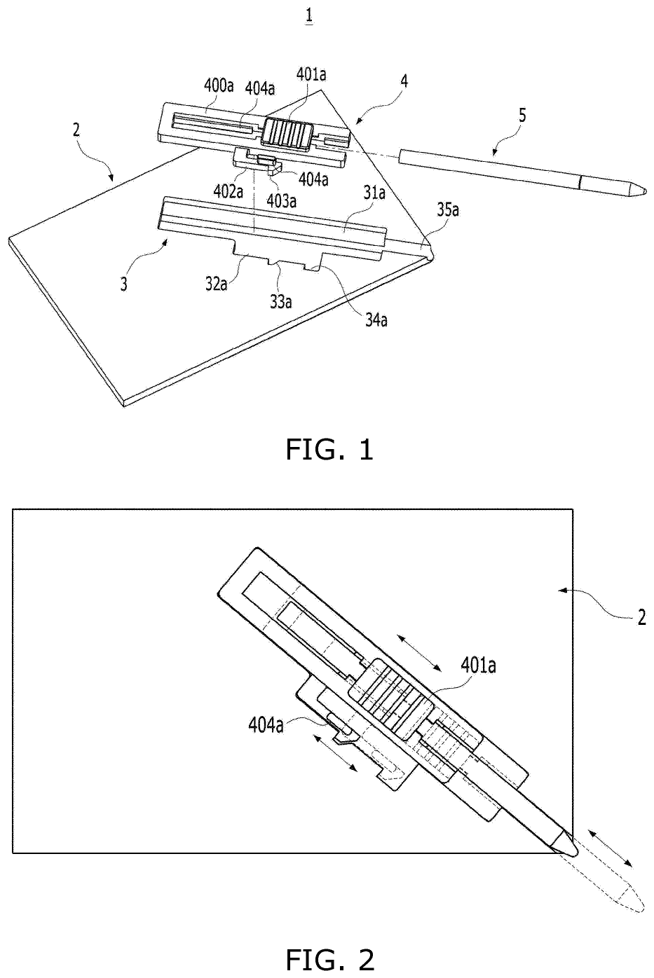

The portable kit 1 for storing a pen according to the present invention includes a base 2, as shown in FIG. 1, and is made of rigid plastic and partially made of a transparent glass material.

The base 2 is rectangular in shape, and is 4 to 5 cm in width and 6 to 8 cm in length. An accommodation portion 3 is located on a diagonal line extending from one vertex of the base 2 to another opposite side. The accommodation portion 3 is a concave space having a depth of 2 to 3 mm. The accommodation portion 3 includes a long rectangular main accommodation portion 31a and a small, long rectangular auxiliary accommodation portion 32a protruding downward from one side of the main accommodation portion 31a. A small triangular stop portion 33a is formed to protrude from a location near the center of one side of the auxiliary accommodation portion 32b, and a square fastening portion 34a larger than the stop portion 33a is formed to protrude from one end of the auxiliary accommodation portion 32a. A guide 35a configured to guide an accommodation target part—a pen 5—through its entry and exit is formed in the center portion of the front end of the main accommodation portion 31a.

A coupling kit 4 that is fastened to the accommodation portion 3 basically has a shape complementary to that of the accommodation portion 3. The coupling kit 4 includes a sideways “U”-shaped body 400a having a long length and a grip portion 401a protruding upward from the top surface of one side of the body 400a. The body 400a is branched in a bridge form, and the steel core-shaped long pen 5 is inserted into a long guide 404a formed in the center of the body 400a. Although the pen 5 may be a writing tool, it does not refer to a bulky writing tool such as a common ballpoint pen, or a fountain pen.

Depression and protrusion ribs are formed on the top surface of the grip portion 401a, and thus make it convenient to push and pull the grip portion 401a with a finger. An “L”-shaped small hook 402a is formed from one side of the body 400a in an integrated manner, and a catch protrusion 403a having the same shape as the stop portion 33a is formed on the side surface of one end of the hook 402a. Furthermore, a rectangular push portion 404a is vertically formed on the top surface of one end of the hook 402a.

The coupling kit 4 is fabricated by, for example, injection molding in an integrated manner, and is fitted into the accommodation portion 3 by means of a press-fitting method and slidable therein.

In other words, as shown in FIG. 2, the location of the coupling kit 4 varies in such a manner that the coupling kit 4 slides between a solid-line retracted position in which the catch protrusion 403a engages with the stop portion 33a of the accommodation portion 3 and a dotted-line advanced position in which the catch protrusion 403a engages with the fastening portion 34a of the accommodation portion 3. The movement and location variation of the coupling kit 4 is performed in such a manner that a user pushes or pulls the grip portion 401a or push portion 404a with a finger. Accordingly, as described later, at least the grip portion 401a, the push portion 404a, and their movement ranges need to be exposed through the window of a cover 20 and to be thus operated by a user. In the advanced position, the front end of the pen 5 is sufficiently exposed, so that writing is facilitated and the replacement of the pen 5 or the insertion of a new pen is possible. Even in the retracted position, the pen 5 is slightly exposed, so that writing is possible and a cap may be worn on the pen 5 in order to prevent the outside from being smeared with ink.

The portable kit 1 for storing a pen according to the present invention is chiefly characterized in that it is a novel article as a whole because a common pen is not accommodated, the slender pen 5 from which a holder is removed and which has a minimum number of members and a minimum size required for writing is used, and the coupling kit 4 and the accommodation portion 3 are formed accordingly. The pen 5 may be simply fabricated using a steel core in which an ink source is contained.

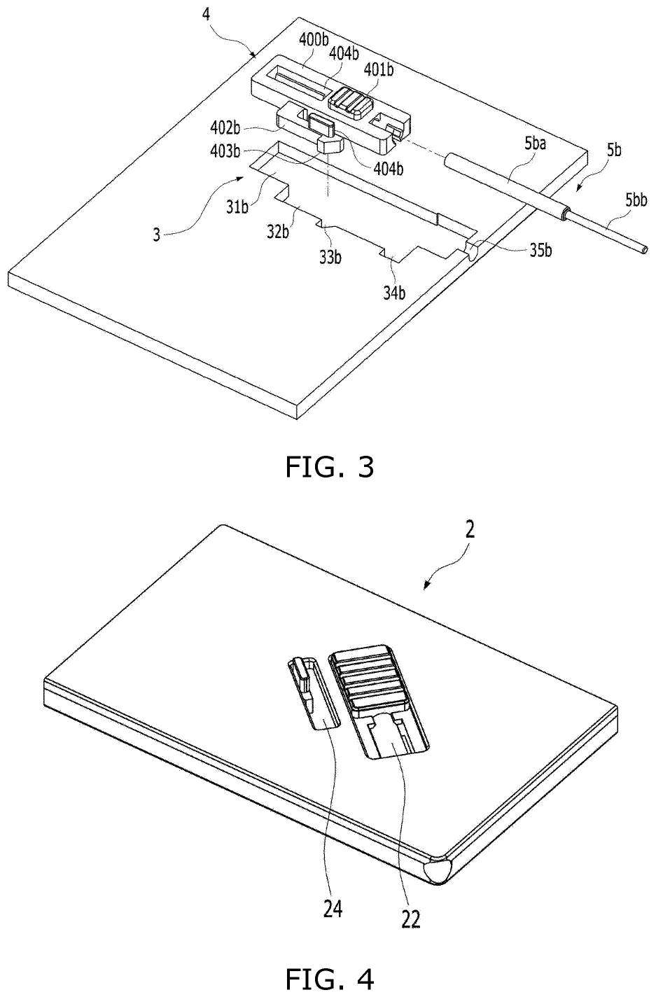

Next, FIG. 3 shows another embodiment of a portable kit 1 for storing a pen according to the present invention. This embodiment is substantially the same as that shown in FIG. 1 except that an accommodation portion 3 extends in parallel with sides of a base 2 and a pen is an electronic pen 5b.

In other words, as shown in FIG. 3, the accommodation portion 3 is located on a horizontal line extending inward from a location near the center of one side of the base 2. The accommodation portion 3 includes a long rectangular main accommodation portion 31b and a small, long rectangular auxiliary accommodation portion 32b protruding from one side of the main accommodation portion 31b. A small triangular stop portion 33b is formed to protrude from a location near the center of one side of the auxiliary accommodation portion 32b, and a square fastening portion 34b larger than the stop portion 33b is formed to protrude from one end of the auxiliary accommodation portion 32b. A guide 35b configured to guide an accommodation target part—an electronic pin—through its entry and exit is formed in the center portion of the front end of the main accommodation portion 31a.

The coupling kit 4 that is fastened to the accommodation portion 3 basically has a shape complementary to that of the accommodation portion 3. The coupling kit 3 includes a sideways “U”-shaped body 400b having a long length and a grip portion 401b protruding upward from the top surface of one side of the body 400b. The body 400b is branched in a bridge form, and a slender column-shaped electronic pin 5b is inserted into a long guide 404b formed in the center of the body 400b. The electronic pen 5b includes a column part 5ba and a tip part 5bb. A chip including a controller and an operation button may be formed in the column part 5ba, and a communication unit for wireless communication, as well as a tip for the pressing of a screen, may be disposed in the tip part 5bb.

Referring to FIG. 3 again, depression and protrusion ribs are formed on the top surface of the grip portion 401b, and thus make it convenient to push and pull the grip portion 401b with a finger. An “L”-shaped small hook 402b is formed from one side of the body 400b in an integrated manner, and a catch protrusion 403b having the same shape as the stop portion 33b is formed at one end of the hook 402b. Furthermore, a rectangular push portion 404b is vertically formed on the top surface of one end of the hook 402b.

The coupling kit 4 is fabricated by, for example, injection molding in an integrated manner, and is fitted into the accommodation portion 3 by means of a press-fitting method and slidable therein, as described with reference to FIG. 2.

FIG. 4 is a perspective view showing a state in which the base 2 of the present invention is covered with the cover 20. The cover 20 is coupled to the base 2 by means of a press-fitting or button-pressing method. Windows 22 and 24 are formed in the cover 4 so that it may be possible to check a part seated on the accommodation portion 3 and withdraw or retract a part. The grip portion 401a is exposed through the window 22, and the push portion 404a is exposed through the window 24. As described above, a user may easily perform the movement and location variation of the coupling kit 4 in such a manner that he or she pushes or pulls the grip portion 401a or push portion 404a with a finger through the windows 22 and 24.

The above-described shapes of the windows are an example. The shapes of the windows may be freely changed as long as the functions of the present invention can be achieved in the case.

According to the present invention, the location of a pen may be checked through the windows of the cover 20 at any time and only the pen be conveniently withdrawn or accommodated by pushing the coupling kit 4 without opening the cover 20 from the base 2 and thus opening a considerable or overall portion of the base 2, which provides considerable convenience, reduces the risk of loss of a part, and improves merchantability.

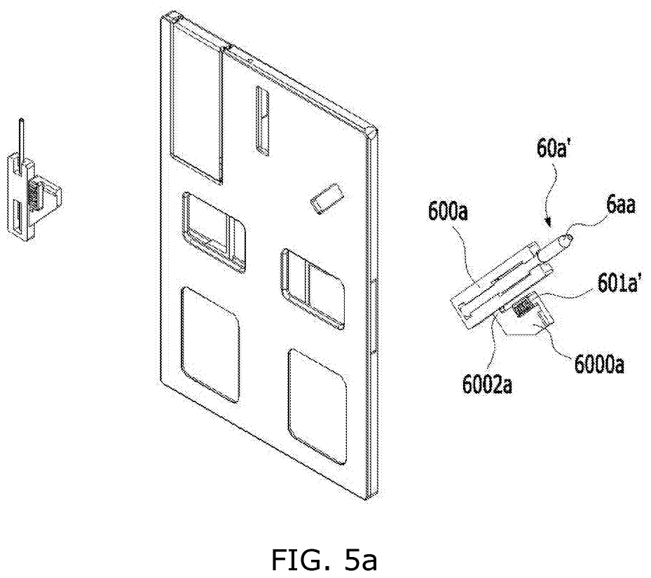

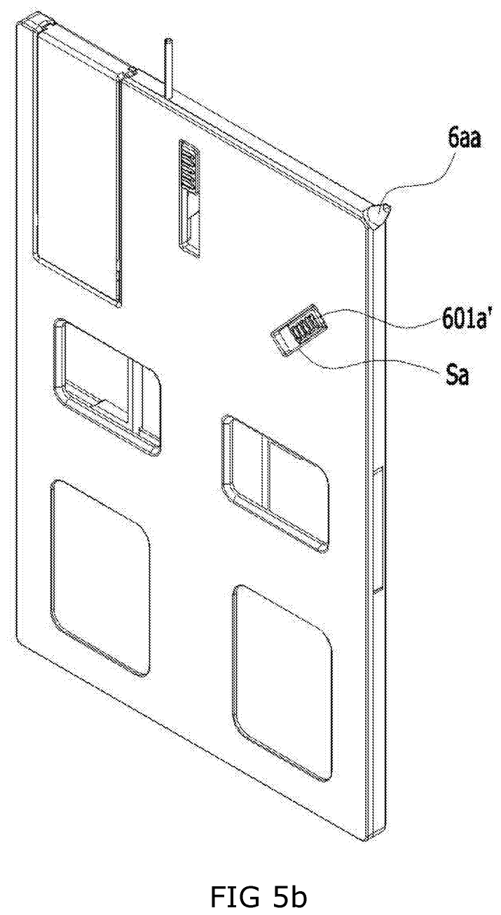

Next, another embodiment of the present invention will be described with reference to FIGS. 5a and 5b. This embodiment is different from the previous embodiment in that a grip portion is not formed on the body of a kit but is disposed on a side surface.

Referring to FIG. 5a, a coupling kit 60a′ includes a long rectangular body 600a which accommodates a pen 6aa, and a flap portion 6000a which is integrated with the body 600a on one side surface of the body 600a through a connecting portion 6002a. Although the flap portion 6000a has a trapezoidal shape the width of the bottom side of which is narrow in the illustrated example, it is not limited thereto. A grip portion 601a′ on which depressions and protrusions are formed such that a user can push the grip portion 601a′ with a finger is formed on the top surface of the flap portion 6000a. The shape of an accommodation portion not shown in the drawing is formed to be complementary to that of the coupling kit 60a′.

The same structure may be further installed in parallel with a case, as shown in FIG. 3, and a description thereof will be omitted because it is the same structure.

Referring to FIG. 5b, a long rectangular shaped slot Sa is formed in a cover 4. A grip portion 601a′ is exposed through the slot Sa. In a state in which the grip portion 601a′ has been pushed along the slot Sa outward, the tip of the pen 6aa is exposed to the outside, and thus a user may easily withdraw it.

The above structure does not require that a hook or catch protrusion is formed unlike the previous embodiment, and thus the fabrication and design of a kit are simple and cost may be reduced.

Although the preferred embodiments of the present invention have been described with reference to the accompanying drawings above, these are presented as examples, and thus the layout of the base and the sizes, shapes, locations, and arrangements of the individual members may be appropriately changed without limiting the scope of the present invention.

In particular, it should be noted that the configurations of the accommodation portions, the coupling kits, and the pens proposed by the present invention are novel configurations that have not been present so far and contribute to the implementation of a compact layout. It will be apparent to those having ordinary knowledge in the art to which the present invention pertains that various alterations and modifications may be made without departing from the spirit of the present invention. The present invention is defined by the following claims.

1. A portable kit for storing a pen, the portable kit comprising a base in which an accommodation portion is formed, wherein the pen is fastened to the accommodation portion and is coupled to a coupling kit having a shape corresponding to that of the accommodation portion and accommodated in the accommodation portion, and a grip portion is formed on the coupling kit and allows the pen to be withdrawn from or retracted into the base in such a manner that the grip portion is pushed with a finger.

2. The portable kit of claim 1, wherein the accommodation portion comprises a long rectangular main accommodation portion and a small, long rectangular auxiliary accommodation portion protruding from one side of the main accommodation portion, a stop portion is formed to protrude from one side of the auxiliary accommodation portion, and a fastening portion is formed to protrude from one end of the auxiliary accommodation portion.

3. The portable kit of claim 2, wherein the coupling kit comprises a body and a grip portion protruding upward from a top surface of one side of the body, a guide configured to accommodate the pen is formed at a center of the body, a hook is formed from one side of the body in an integrated manner, and a catch protrusion having a shape identical to that of the stop portion is formed on a side surface of the hook, so that the coupling kit is slidable between a retracted position in which the catch protrusion engages with the stop portion of the accommodation portion and an advanced position in which the catch protrusion engages with the fastening portion of the accommodation portion.

4. The portable kit of claim 2, wherein a push portion is vertically formed on a top surface of one end of the hook.

5. The portable kit of claim 2, wherein the pen is a writing tool having a long steel core shape in which an ink source is contained.

6. The portable kit of claim 2, wherein the pen is an electronic pen having a chip including a controller and a tip for pressing a screen.

7. The portable kit of claim 2, further comprising a cover which selectively opens and closes the base, wherein a window through which the grip portion is exposed and along which the grip portion is movable is opened and formed in the cover.

8. The portable kit of claim 1, wherein the coupling kit comprises a long rectangular body configured to accommodate the pen and a flap portion integrated with the body on one side surface of the body through a connecting portion, and a grip portion on which depressions and protrusions are formed such that the grip portion is pushed with a finger is formed on a top surface of the flap portion.
